(19) United States
(12) Patent Application Publication
(10) Pub. No.: US 2025/0086251 A1
(43) Pub. Date: Mar. 13, 2025

(54) MODULAR HYPERVECTOR FACTORIZATION

(71) Applicant: INTERNATIONAL BUSINESS MACHINES CORPORATION, ARMONK, NY (US)

(72) Inventors: Aleksandar Terzic, Dietikon (CH); Jovin Langenegger, Gerlikon (CH); Michael Andreas Hersche, Zurich (CH); Abu Sebastian, Adliswil (CH); Abbas Rahimi, Rueschlikon (CH); Kumudu Geethan Karunaratne, Adliswil (CH)

(21) Appl. No.: 18/464,336

(22) Filed: Sep. 11, 2023

(51) Int. Cl. G06F 17/16; G06F 5/01

(52) U.S. Cl. CPC G06F 17/16; G06F 5/01

(57) ABSTRACT

An approach for factorizing hypervectors using a resonator network may be provided herein. The approach may involve providing alternative implementations of a step for each step of the iterative process of the resonator network. An input hypervector representing a data structure may be received, by a resonator network. The approach may further involve selecting a step from the provided implementation of each step of the iterative process. The iterative process may be executed based on the selected implementations, thereby factorizing the input hypervector.

### BACKGROUND

The present invention relates to the field of digital computer systems, and more specifically, to a method for factorizing hypervectors.

Hypervectors may be factorized using resonator networks and bundling operations. Resonator networks are a type of recurrent neural network that interleaves vector symbolic architecture multiplication operations and pattern completion. Given a hypervector formed from an element-wise product of two or more atomic hypervectors (each from a fixed codebook), the resonator network may find its factors. The resonator network may iteratively search over the alternatives for each factor individually rather than all possible combinations until a set of factors is found that agrees with the input hypervector.

### SUMMARY

Various embodiments provide a method for performing factorization using a factorization system, computer program product and computer system as described by the subject matter of the independent claims. Advantageous embodiments are described in the dependent claims. Embodiments of the present invention can be freely combined with each other if they are not mutually exclusive.

In one aspect, the invention relates to a method for performing factorization using a factorization system, the factorization system comprising a resonator network that is configured for performing an iterative process in order to factorize an input hypervector into individual hypervectors representing a set of concepts respectively, the iterative process comprising for each concept of the set of concepts at least: an inference step for computing an unbound version of a hypervector representing the concept by an unbinding operation between the input hypervector and estimate hypervectors of the other concepts, a similarity step to compute a similarity vector indicating a similarity of the unbound version with each candidate code hypervector of the concept, and a superposition step to generate an estimate of a hypervector representing the concept; the method comprising: providing for each step of the iterative process alternative implementations of the step; receiving an input hypervector representing a data structure; selecting from the provided implementations for each step of the iterative process a specific implementation of the step; executing the iterative process using the selected implementations, thereby factorizing the input hypervector.

In one aspect the invention relates to a factorization system, the factorization system comprising a resonator network that is configured for performing an iterative process in order to factorize an input hypervector into individual hypervectors representing a set of concepts respectively, the iterative process comprising for each concept of the set of concepts at least: an inference step for computing an unbound version of a hypervector representing the concept by an unbinding operation between the input hypervector and estimate hypervectors of the other concepts, a similarity step to compute a similarity vector indicating a similarity of the unbound version with each candidate code hypervector of the concept, and a superposition step to generate an estimate of a hypervector representing the concept; the factorization system being configured for: providing for each step of the iterative process alternative implementations of the step; receiving an input hypervector representing a data structure; selecting from the provided implementations for each step of the iterative process a specific implementation of the step; executing the iterative process using the selected implementations, thereby factorizing the input hypervector.

Embodiments may further include approaches to factorize an input hypervector representing a plurality of concepts into individual hypervectors each representing a concept from a the plurality of concepts, through iterative processing of a resonator network. Further, embodiments may involve receiving an input hypervector representing a data structure comprised of a plurality of concepts. Further, embodiments may involve unbinding the input hypervector, into a plurality of unbound hypervectors, wherein the each of the plurality of unbound hypervectors corresponds to a single concept from the plurality of concepts of the data structure. Further, embodiments may involve generating one or more similarity vectors for each of the unbound hypervectors, wherein each of the one or more similarity vectors is based on the similarity of the unbound hypervector and one or more candidate code hypervectors representing each of the plurality of concepts. Further, embodiments may involve and generating a plurality of a principal hypervectors, wherein each principal hypervectors is an estimate which represents one concept of the plurality of concepts, based at least in part on the one or more similarity vectors corresponding to the one concept.

Further, embodiments may involve generating a similarity vector is based on one of the following: a dot product, L1 norm, L2 norm, or L\hat{ }∞ norm. Further, embodiments may involve unbinding the input hypervector, based on a circular convolution or an addition and modulo operation. Further, embodiments may involve adding noise to the similarity vector of the hypervector, wherein the noise is gaussian noise or uniform noise. Further, embodiments may further comprise separating the similarity vectors, based on a softmax operation or an identity operation. Further, embodiments may further comprise sparsifying one or more elements of the similarity vectors, wherein sparsifying is based on one or the following: a pre-determined threshold, a dynamic threshold, a Top-A operation, or an absolute value larger than a mean of all. Further, in an embodiment generating the plurality of principal hypervectors comprises combining through a linear combination each of the candidate code hypervectors with weights to generate a plurality of bundled weights, based on the sparsified similarity vector corresponding to the candidate code hypervector and applying the plurality of bundled weights to a selection function. Further in an embodiment, the approach factorize an input hypervector representing a plurality of concepts into individual hypervectors each representing a concept from a the plurality of concepts, through iterative processing of a resonator network performs a plurality of iterations until a convergence criterion is fulfilled. In an embodiment, the convergence criteria is when a value of at least one element of each of the plurality of similarity scores exceeds a threshold and in another embodiment the convergence criteria is when a predefined number of iterations.

An embodiment of the invention may be a computer program product comprising one or more computer readable storage devices and program instructions stored on the one or more computer readable storage devices, wherein the program instructions are executable by a computer processor to perform one or more operations or processes described throughout this specification.

An embodiment of the invention may be a computer system comprising one or more computer processors, one or more computer readable storage devices, and program instructions stored on the one or more computer readable storage devices for execution by at least one of the one or more computer processors. to perform one or more of the operations or processes described throughout this specification.

### BRIEF DESCRIPTION OF THE DRAWINGS

FIG. 1 is a diagram illustrating a resonator network system in accordance with an embodiment of the invention.

FIG. 2 is a flowchart of a method for performing factorization using a factorization system in accordance with an embodiment of the invention.

FIG. 3 is a diagram of a modular structure of a factorization system in accordance with an embodiment of the invention.

FIG. 4 is a flowchart of a method for bundling a set of hypervectors in accordance with an embodiment of the invention.

FIG. 5 is a diagram illustrating the bundling operation in accordance with an embodiment of the invention.

FIG. 6 is a diagram illustrating the bundling operation in accordance with an embodiment of the invention.

FIG. 7 is a diagram illustrating the binding operation in accordance with an embodiment of the invention.

FIG. 8 is a flowchart of a method for factorizing a hypervector in accordance with an embodiment of the invention.

FIG. 9 is a computing environment in accordance with an embodiment of the invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Hyperdimensional computing (HDC) represents data as large vectors called hypervectors. An entity may be represented using these hypervectors. A hypervector may be a vector of bits, integers, real or complex numbers. The hypervector is a vector having a dimension D higher than a minimum dimension, e.g., D>100. The hypervector according to the present subject matter may be sparse hypervector. The sparse hypervector may comprise a fraction of non-zeros which is smaller than a predefined maximum fraction (e.g., the maximum fraction may be 10%). The sparsity of the hypervectors may be chosen or may be dictated by the encoder (e.g., such as a neural network) that produced the hypervectors. HDC may enable computations on hypervectors via a set of mathematical operations. These operations may include a bundling operation. The bundling operation may also be referred to as addition, superposition, chunking, or merging. The bundling operation may combine several hypervectors into a single hypervector.

In one example, the hypervector may be segmented according to the present subject matter into a set of blocks so that a hypervector comprises a set of S blocks, each block having a dimension L, wherein D=S×L and S is the number of blocks in a hypervector. In one example, the hypervector may comprise a number S of blocks, wherein the block size may be higher than one, L>1. That is, each block of each hypervector may comprise L elements. The processing of the hypervectors may be performed blockwise.

According to one example, the hypervector comprises binary values {0, 1}^{D} and has a sparsity smaller than a sparsity threshold. The sparsity may, for example, be the fraction of non-zero values in the hypervector. The present subject matter may enable an efficient bundling of hypervectors with controlled sparsity. According to one example, the sparsity threshold being in a range of: 0.3%-50%. Example values of the sparsity threshold may be 0.39%, 0.4%, 1% or 13%.

The factorization system may be used for querying data structures through their hypervector representations. Data structures may enable to represent cognitive concepts, such as colours, shapes, positions, etc. Each cognitive concept may comprise items e.g., items of the colour concept may comprise red, green, blue etc. The data structure may contain a combination (e.g., product) of multiple components each representing a cognitive concept. For example, the data structure may be an image of a red disk in the bottom right and a green rectangle in the top left, wherein the cognitive concepts may be the colour, shape, and position. In another example, a data structure may form a distributed representation of a tree, wherein each leaf in the tree may represent a concept, and each type of traversal operations in the tree may represent concepts. The data structure may be encoded by an encoder into a hypervector that uniquely represents the data structure.

The encoder may combine hypervectors that represent individual concepts with operations in order to represent a data structure. For example, the above mentioned image may be described as a combination of multiplication (or binding) and addition (or superposition) operations as follows: (bottom right*red*disk)+(top left*green*rectangle). The encoder may represent the image using hypervectors that represent the individual concepts and said operations to obtain the representation of the image as a single hypervector that distinctively represents the knowledge that the disk is red and placed at the bottom right and the rectangle is green and placed at the top left. The encoder may be defined by a vector space of a set of hypervectors which encode a set of cognitive concepts and algebraic operations on this set. The algebraic operations may, for example, comprise a superposition or bundling operation and a binding operation. In addition, the algebraic operations may comprise a permutation operation. The vector space may, for example, be a D-dimensional space, where D>100. The hypervector may be a D-dimensional vector comprising D numbers that define the coordinates of a point in the vector space. The D-dimensional hypervectors may be in {0,1}^{D}. For example, a hypervector may be understood as a line drawn from the origin to the coordinates specified by the hypervector. The length of the line may be the hypervector's magnitude. The direction of the hypervector may encode the meaning of the representation. The similarity in meaning may be measured by the size of the angles between hypervectors. This may typically be quantified as a dot product between hypervectors. The encoder may be a decomposable (i.e., factored) model to represent the data structures. This may be advantageous as the access to the hypervectors may be decomposed into the primitive or atomic hypervectors that represent the individual items of the concepts in the data structure. For example, the encoder may use a Vector Symbolic Architecture (VSA) technique in order to represent the data structure by a hypervector. The encoder may enable to perform an elementwise multiply operation. The encoder may, for example, comprise a trained feed-forward neural network.

Hence, the encoding of data structures may be based on a predefined set of F concepts, where F>1 and candidate items that belong to each of the F concepts. Each candidate item may be represented by a respective hypervector. Each concept may be represented by a matrix of the hypervectors representing candidate items of the concept, e.g., each column of the matrix may be a distinct hypervector. The matrix may be referred to as codebook and the hypervector representing one item of the concept may be referred to as code hypervector. The components of the code hypervector may, for example, be randomly chosen. For example, a codebook representing the concept of colours may comprise seven possible colours as candidate items, a codebook representing the concept of shapes may comprise 26 possible shapes as candidate items etc. The codebooks representing the set of concepts may be referred to as X₁, X₂ . . . X_{F} respectively. Each i-th codebook Xᵢ may comprise Mₓ_{ᵢ} code hypervectors xᵢ¹ . . . [symbol] , Mₓ_{ᵢ}>1.

Querying such data structures through their hypervector representations may require decoding the hypervectors. Decoding such hypervectors may be performed by testing every combination of code hypervectors. However, this may be very resource consuming. The present subject matter may solve this issue by using the factorization system. The factorization system may perform factorization using a resonator network. The resonator network may be an iterative approach. In particular, the resonator network can efficiently decode a given hypervector without needing to directly test every combination of factors making use of the fact that the superposition operation is used for the encoding of multiple concept items in the given hypervector and the fact that randomized code hypervectors may be highly likely to be close to orthogonal in the vector space, meaning that they can be superposed without much interference. For that, the resonator network may search for possible factorizations of the given hypervector by combining a strategy of superposition and clean-up memory. The clean-up memory may reduce some crosstalk noise between the superposed concept items. The resonator network combines the strategy of superposition and clean-up memory to efficiently search over the combinatorially large space of possible factorizations.

Thus, in each iteration, the resonator network may be configured to execute a sequence of steps (or processing steps) such as the inference step, the similarity step etc. For each step, the present subject matter may provide alternative possible implementations of the step. For example, the similarity step may be implemented by using dot product, L¹ norm, L² norm, L^{∞} norm etc. Thus, before executing the resonator network, a specific implementation may be selected for each step of the iterative process. In one selection example, the implementation of a given step may be randomly selected from the possible implementations of the step. This may particularly be advantageous in case the implementations are equally performant. In one selection example, the implementation of a given step may be selected based on received user input (e.g., the user input may indicate which implementation to use for the given step). The resonator may thus be executed to factorize hypervectors using the selected implementations.

The term “implementation” of a step X as used herein refers to a software module. The software module may be a group of code representing instructions that can be executed at a computing system or processor to perform the step X. The software module may be provided as a software application, a Dynamic Link Library (DLL), a software object, a software function, a software engine, an executable binary software file or the like. For example, the implementation of the similarity step may be a software module whose execution would compute the similarity step using a specific technique such as L² norm that is associated to the implementation.

However, hypervectors may be sparse, meaning that they contain a small fraction of non-zeros. This may render the operations such as binding of hypervectors problematic and thus the factorization using the resonator network may not be accurate. The sparse hypervector may be a hypervector comprising a fraction of non-zeros which is smaller than a predefined maximum fraction (e.g., the maximum fraction may be 10%). The fraction of non-zeros may be the ratio of the non-zeros and the total number D of elements of the hypervector. The present subject matter may solve this issue by processing the hypervectors at block level rather than at individual element level during the iterative process. For that, the hypervector may be segmented into a set of blocks so that a hypervector comprises a set of S blocks, each block having a dimension L, wherein D=S×L. S is the number of blocks in a hypervector which may also be the number of non-zeros in the hypervector. The blocks may enable blockwise operations, that is, an operation involving hypervectors may be performed on corresponding blocks of the hypervectors. For example, an addition of two hypervectors may comprise addition of pairs of blocks of the two hypervectors, wherein each pair comprises two corresponding blocks (e.g., the first block of the first hypervector is to be processed with the first block of the second hypervector, the second block of the first hypervector is to be processed with the second block of the second hypervector, and so forth). The iterative process may process blockwise the hypervectors in one or more steps of the iterative process. These steps may involve binding and bundling operations. The blockwise binding and unbinding operations of two hypervectors x and y may be performed using the hypervectors. For example, the binding operation x⊙y, where ⊙ refers to the binding operation, may be performed using the circular convolution of hypervectors x and y. The unbinding operation x\textcircled{/}y, where \textcircled{/} refers to the unbinding operation, may be performed using the circular correlation of hypervectors x and y. The iterative process may stop if a convergence criterion is fulfilled. The convergence criterion may, for example, require a predefined number of iterations to be reached.

Thus, the iterative process may comprise multiple steps which are executed in each iteration of the process. Each step of these steps may be associated with multiple possible implementations. The present subject matter may efficiently factorize the hypervector representing a data structure into the primitives from which it is composed. For example, given a hypervector formed from an element-wise product of two or more hypervectors, its factors (i.e., the two or more hypervectors) may be efficiently found. This way, a nearest-neighbour lookup may need only search over the alternatives for each factor individually rather than all possible combinations. This may reduce the number of operations involved in every iteration of the resonator network and hence reduce the complexity of execution. This may also solve larger size problems (at fixed dimensions), and improve the robustness against noisy input hypervectors.

Assuming for a simplified description of the iterative process of the resonator network that the set of concepts comprises three concepts i.e., F=3, but it is not limited to. The codebooks/matrices representing the set of concepts may be referred to as X, Y and Z respectively (i.e., X=X₁, Y=X₂ and Z=X₃.). The codebook X may comprise Mₓ code hypervectors x¹ . . . x^{M}^{ₓ}. The codebook Y may comprise M_{y} code hypervectors y¹ . . . y^{M}^{_{y}}. The codebook Z may comprise M_{z} code hypervectors z¹ . . . z^{M}^{_{z}}. This may define a search space of size M=Mₓ·M_{y}·M_{z}. Since the resonator network is used, a data structure may be represented by a hypervector s which may be factorized into individual hypervectors representing the set of concepts respectively i.e., that is, the hypervector s may be defined as follows s=x^{α}⊙y^{β}⊙z^{γ}. The iterative process may find x^{α}, y^{β}, z^{γ} where α∈{1, 2, . . . , Mₓ }, β∈{1, 2, . . . , M_{y}} and γ∈{1, 2, . . . , M_{z}}.

Given the hypervector s that represents the data structure and given the set of predefined concepts, an initialization step may be performed by initializing an estimate of the hypervector that represents each concept of the set of concepts. The initial estimates \hat{x}(0), ŷ(0) and \hat{z}(0) may, for example, be defined as a superposition of all candidate code hypervectors of the respective concept e.g., \hat{x}(0)=g(Σ_{i=1, . . . , M}_{ₓ} xⁱ), ŷ(0)=g(Σ_{j=1, . . . , M}_{_{y}} y^{j}) and \hat{z}(0)=g(Σ_{k=1, . . . , M}_{_{z}} z^{k}), where g is a selection function such as an argmax function. The term “estimate of a hypervector u” refers to a hypervector of the same size as hypervector u. The resonator network system may comprise a first buffer for storing the hypervector s and a second set of buffers for (initially) storing the estimates \hat{x}(0), ŷ(0) and \hat{z}(0).

And, for each current iteration t of the iterative process, the following may be performed. Unbound hypervectors \tilde{x}(t), \tilde{y}(t) and \tilde{z}(t) may be computed. Each of the unbound hypervectors may be an estimate of the hypervector that represents the respective concept of the set of concepts. Each of the unbound hypervectors may be inferred from the hypervector s based on the estimates of hypervectors for the other remaining F−1 concepts of the set of concepts. The unbound hypervectors may be computed as follows: \tilde{x}(t)=s\textcircled{/}ŷ(t)\textcircled{/}\hat{z}(t), \tilde{y}(t)=s\textcircled{/}\hat{x}(t)\textcircled{/}\hat{z}(t) and \tilde{z}(t)=s\textcircled{/}\hat{x}(t)\textcircled{/}ŷ(t), where \textcircled{/} refers to the unbinding operation. The unbinding operation of two hypervectors may be performed using different implementations such as a circular convolution of the two hypervectors or addition and modulo operation. For example, if the circular convolution implementation is selected, the unbinding operation for producing the unbound hypervectors may be performed using the circular convolution. This may be referred to as an inference step. An example implementation of the addition and modulo operation is described below.

The inference step may, however, be noisy if many estimates (e.g., F−1 is high) are tested simultaneously. The unbound hypervectors \tilde{x}(t), \tilde{y}(t) and \tilde{z}(t) may be noisy. This noise may result from crosstalk of many quasi-orthogonal code hypervectors, and may be reduced through a clean-up memory. After providing the unbound version of a hypervector of a given concept, the clean-up memory may be used to find the similarity of each code hypervector of said concept to the unbound version of the hypervector. This may be referred to as a similarity step. The similarity may be computed using a selected one of different implementations such as a dot product, L² norm and L¹ norm. For example, if the dot product implementation is selected, the similarity may be computed as a dot product of the codebook that represents said concept by the unbound version of the hypervector, resulting in an attention vector aₓ(t), a_{y}(t) and a_{z}(t) respectively. The attention vector may be referred to herein as similarity vector. The similarity vectors aₓ(t), a_{y}(t) and a_{z}(t) have sizes Mₓ, M_{y} and M_{z} respectively and may be obtained as follows: aₓ(t)=X^{T}\tilde{x}(t)∈ [symbol] , a_{y}(t)=Y^{T}\tilde{y}(t)∈ [symbol] and a_{z}(t)=Z^{T}\tilde{z}(t)∈ [symbol] . The obtained similarity vectors are provided using a dot product similarity; however, it is not limited to as other similarity metrics may be used and which may be implemented differently. For example, the similarity vector aₓ(t) may indicate a similarity of the unbound hypervector \tilde{x}(t) with each candidate code hypervector of the concept (X) e.g., the largest element of aₓ(t) may indicate the code hypervector which matches best the unbound hypervector \tilde{x}(t). The similarity vector a_{y}(t) may indicate a similarity of the unbound hypervector \tilde{y}(t) with each candidate code hypervector of the concept (Y) e.g., the largest element of a_{y}(t) may indicate the code hypervector which matches best the unbound hypervector \tilde{y}(t). The similarity vector a_{z}(t) may indicate a similarity of the unbound hypervector \tilde{z}(t) with each candidate code hypervector of the concept (Z) e.g., the largest element of a_{z}(t) indicates the code hypervector which matches best the unbound hypervector \tilde{z}(t).

A superposition (or bundling) using the similarity vectors aₓ(t), a_{y}(t) and a_{z}(t) as weights may be performed and optionally followed by the application of a selection function g. This may be referred to as the superposition step. This superposition step may be performed using the similarity vectors aₓ(t), a_{y}(t) and a_{z}(t) as follows: \hat{x}(t+1)=g(aₓ(t)X), ŷ(t+1)=g(a_{y}(t)Y) and \hat{z}(t+1)=g(a_{z}(t)Z) respectively, in order to obtain the current estimates \hat{x}(t+1), ŷ(t+1) and \hat{z}(t+1) respectively of the hypervectors that represent the set of concepts. In other words, the superposition step generates each of the estimates \hat{x}(t+1), ŷ(t+1) and \hat{z}(t+1) representing the respective concept by a linear combination of the candidate code hypervectors (provided in respective matrices X, Y and Z), with weights given by the respective similarity vectors aₓ(t), a_{y}(t) and a_{z}(t), and optionally followed by the application of the selection function g. The superposition step may involve a bundling operation which may be performed according to the present method. The bundling operation may be performed using a selected implementation of different possible implementations as described herein. For example, the bundling operation may be performed by weighted additive superposition of code vectors, where the weights are given by the values of the similarity vector. The superposition may for example involve one or more bundling operations which are performed by the present method. Hence, the current estimates of the hypervectors representing the set of concepts respectively may be defined as follows \hat{x}(t+1)=g(XX^{T} (s\textcircled{/}ŷ(t)\textcircled{/}\hat{z}(t))), ŷ(t+1)=g(YY^{T} (s\textcircled{/}\hat{x}(t)\textcircled{/}\hat{z}(t))) and \hat{z}(t+1)=g(ZZ^{T} (s\textcircled{/}\hat{x}(t)\textcircled{/}ŷ(t))) where g is the selection function, for example, an argmax function.

The iterative process may stop if a convergence criterion is fulfilled. The convergence criterion may, for example, require that the value of at least one element of each similarity vector aₓ(t), a_{y}(t) and a_{z}(t) exceeds a threshold. In another example, the convergence criterion may require a predefined number of iterations to be reached.

The present subject matter may enable an efficient bundling of hypervectors with arbitrary sparsity. In one example implementation of the bundling operation, the bundling operation may be performed as follows: given hypervectors A, B and C of size D each, the bundling operation B=A+C, may be performed as follows: each of the hypervectors A and C may be segmented into S blocks, the element wise sum of the hypervectors A and C may be performed to obtain the sum hypervector B, elements of each block of the sum hypervector B that fulfill the selection criterion may be selected, and may thus preserved and the non-selected elements may be set to zero in the sum hypervector B. In addition, the present subject matter may provide different implementations of the bundling operation by using different selection criterions. According to one example implementation of the bundling operation, the selection criterion requires a predefined number a of largest elements per block of the sum hypervector. In one example, the predefined number a may be a hyperparameter of randomly selected value or user defined value. This example may enable a bundling procedure which may have a significantly larger bundling capacity compared to the previous state-of-the-art. According to one example implementation of the bundling operation, the selection criterion requires the element of the block exceeds a threshold value, wherein if no element exceeds the threshold value in a block, all elements of the block are selected. This example may provide a threshold-based bundling operation which may be more amenable to hardware implementations as it may reduce to element-wise comparisons. According to one example, the method further comprises normalizing the bundled hypervector per block.

The present resonator implementation may mitigate the following limitations of an existing resonator. The existing sparse resonator may not factorize S=4 sparse hypervectors at problem sizes larger than M=103 for a number 3 of codebooks and size of 10 per codebook. This may limit the deep neural network (DNN) application to problems with up to 103 classes, making extreme classification problems (>100 k classes) not viable with S=4. The existing resonator may not factorize S=2 sparse hypervectors at any problem size. Concretely, at problem size M=1024, the existing resonator may achieve a less than 10% factorization accuracy. The architecture of the existing resonator may be rigid, and may not allow for simple modification which may boost factorization accuracy depending on the problem at hand.

According to one example, the similarity step may further comprise a step of adding noise to the similarity vectors. The adding noise step may be performed using a selected one of different implementations such as an implementation that adds gaussian noise and another implementation that adds uniform noise.

According to one example, the similarity step may further comprise a similarity separation step for applying a function to the similarity vectors. The similarity separation step may be performed using a selected one of different implementations such as an implementation that uses a softmax function and another implementation that uses an identity function.

According to one example, the similarity step comprises a step of sparsifying the similarity vector before the superposition step is performed on the sparsified similarity vector. That is, the similarity vectors aₓ(t), a_{y}(t) and a_{z}(t) are sparsified in order to obtain the sparsified similarity vectors a′ₓ(t), a′_{y}(t) and a′_{z}(t) respectively. The scarification step may for example be implemented using one of multiple possible implementations such as an implementation as described below. The sparsification of the similarity vector may be performed, in accordance with a selected implementation, by activating a portion of the elements of the similarity vector and deactivating the remaining portion of the elements of the similarity vector. Activating an element of the similarity vector means that the element may be used or considered when an operation is performed on the similarity vector. Deactivating an element of the similarity vector means that the element may not be used or considered when an operation is performed on the similarity vector. For example, a′ₓ(t)=kact(aₓ(t)), a′_{y}(t)=kact(a_{y}(t)) and a′_{z}(t)=kact(a_{z}(t)), where kact is an activation function. In this case, the superposition step described above may be performed on the sparsified similarity vectors a′ₓ(t), a′_{y}(t) and a′_{z}(t) (instead of the similarity vectors aₓ(t), a_{y}(t) and a_{z}(t)) as follows: \hat{x}(t+1)=g(Xa′ₓ(t)), ŷ(t+1)=g(Ya′_{y}(t)) and \hat{z}(t+1)=g(Za′_{z}(t)) respectively, in order to obtain the current estimates \hat{x}(t+1), ŷ(t+1) and \hat{z}(t+1) respectively of the hypervectors that represent the set of concepts. In other words, the superposition step generates each of the estimates \hat{x}(t+1), ŷ(t+1) and \hat{z}(t+1) representing the respective concept by a linear combination of the candidate code hypervectors (provided in respective matrices X, Y and Z), with weights given by the respective sparsified similarity vectors a′ₓ(t), a′_{y}(t) and a′_{z}(t), followed by the application of the selection function g. The weights given by the sparsified similarity vector are the values of the sparsified similarity vector. Hence, the current estimates of the hypervectors representing the set of concepts respectively may be defined as follows \hat{x}(t+1)=g(Xkact(X^{T} (s\textcircled{/}ŷ(t)\textcircled{/}\hat{z}(t)))), ŷ(t+1)=g(Ykact(Y^{T} (s\textcircled{/}\hat{x}(t)\textcircled{/}\hat{z}(t)))) and \hat{z}(t+1)=g(Zkact(Z^{T} (s\textcircled{/}\hat{x}(t)\textcircled{/}ŷ(t)))).

This example may be advantageous because the sparsification may result in doing only a part of vector multiplication-addition operations instead of all Mₓ, M_{y} or M_{z} operations and thus may save processing resources. The present subject matter may provide different implementations for performing the sparsification step.

In one first example implementation of the sparsification step, the activation function kact may only activate the top j values in each of the similarity vectors aₓ(t), a_{y}(t) and a_{z}(t), where j<<Mₓ, j<<M_{y} and j<<M_{z} respectively, and deactivate the rest of elements by setting them to a given value (e.g., zero) to produce a′ₓ(t), a′_{y}(t) and a′_{z}(t) respectively. The top j values of a similarity vector may be obtained by sorting the values of the similarity vector and selecting the j first ranked values. j may, for example, be a configurable parameter whose value may change e.g., depending on available resources.

This example may be advantageous because the sparsification may reduce the amount of computations, increase the size of solvable problems by an order of magnitude at a fixed vector dimension, and improve the robustness against noisy input vectors.

In a second example implementation of the sparsification step, the activation function kact may activate each element in each of the of the similarity vectors aₓ(t), a_{y}(t) and a_{z}(t) only if its absolute value is larger than a mean of all elements of the respective similarity vector. The mean is determined using the absolute values of the similarity vector.

This example may be advantageous because the sparsification may improve the computational complexity of the first embodiment by removing the sort operation needed to find the top-j elements.

In a third example implementation of the sparsification step, the activation function kact may be implemented as follows: in case the maximum value of the sparsified similarity vector exceeds a predefined threshold, the maximum value may be maintained and remaining elements of the sparsified similarity vector may be set to zero. This may be referred to as a pullup activation.

The following is an example of the addition and modulo operation. For example, for binding two blocks of two hypervectors, addition and modulo binding may only work if the blocks are fully sparse, meaning that each block only has one non-zero element. Additionally, this operation assumes that the non-zero element is a 1, that's is, the blocks are binary blocks. For example, the first block is [0, 1, 0, 0] and the second block is [0, 0, 0, 1]. Because the blocks are fully sparse, they can equivalently be represented by only showing the location within the block of the non-zero element; this may be called offset representation. This may result in the following representations of the two blocks: [0, 1, 0, 0]<->1 and [0, 0, 0, 1]<->3. The representation “1” indicates that the second element of the first block has value 1. The representation “3” indicates that the fourth element of the second block has value 1. In this case, the two hypervectors may be bound to each other by computing the sum of their offset representations. However, simply summing the two offset representations may result in a block which is longer than the two inputs to the binding operation. To alleviate this, the final bound block is calculated as the sum of offset representations modulo block length. In this case, the block length L is 4, so the binding results in: (1+3) mod 4=0 which is equivalent to the vector [1, 0, 0, 0], because the offset representation “0” refers to the first element of the block. Circular convolution may implement this exact operation in case the inputs are fully sparse in binary. It is however not restricted to such inputs; it is well-defined for all finite-length block with bounded elements.

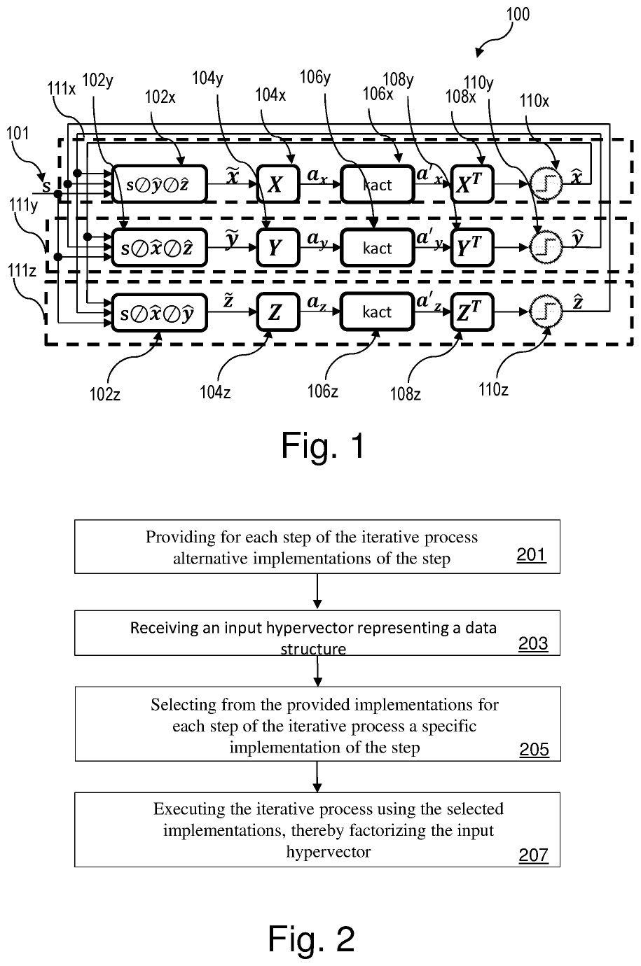

FIG. 1 is a diagram illustrating a resonator network system 100 in accordance with an example of the present subject matter.

The resonator network system 100 may be configured to execute a resonator network to decode hypervectors that are encoded in a vector space defined by three concepts. The codebooks representing the set of concepts may be referred to as X, Y and Z respectively. The codebook X may comprise Mₓ code hypervectors x¹ . . . x^{M}^{ₓ}, Mₓ>1. The codebook Y may comprise M_{y} code hypervectors y¹ . . . y^{M}^{_{y}}, M_{y}>1. The codebook Z may comprise M_{z} code hypervectors z¹ . . . z^{M}^{_{z}}, M_{z}>1. This may define a search space of size M=Mₓ·M_{y}·M_{z}. The resonator network may, for example, be a recurrent neural network. The resonator network system 100 may comprise network nodes 102x, 102y and 102z that represent respectively the three concepts. The resonator network system 100 may further comprise memories 104x, 104y and 104z for storing the codebooks X, Y and Z respectively. The resonator network system 100 may further comprise computation units 108x, 108y and 108z comprising respectively memories for storing the transposes X^{T}, Y^{T} and Z^{T} of the codebooks respectively. The resonator network system 100 may further comprise activation units 106x, 106y and 106z for the three concepts respectively. The activation units 106x, 106y and 106z may, for example, implement the activation function kact according to the present subject matter. The resonator network system 100 may further comprise selection units 110x, 110y and 110z for the three concepts respectively. The selection units 110x, 110y and 110z may, for example, implement a selection function such as an argmax function. As indicated in FIG. 1, the concepts of the vector space may be associated with processing lines 111x, 111y and 111z respectively, wherein each processing line may provide an estimate of a hypervector representing the respective concept, e.g., the processing line 111x provides estimates \hat{x}, the processing line 111y provides estimates ŷ and the processing line 111z provides estimates \hat{z}.

An input hypervector 101 named s may be received by the resonator network system 100. The input hypervector s may be the result of encoding a data structure such as a coloured image comprising MNIST digits. The encoding may be performed by a VSA technique. At an initial state t=0 the resonator network system 100 may initialize an estimate of the hypervector that represents each concept of the set of concepts as a superposition of all candidate code hypervectors of said concept as follows: \hat{x}(0)=g(Σ_{i=1, . . . , M}_{ₓ} xⁱ), ŷ(0)=g(Σ_{j=1, . . . , M}_{_{y}} yⁱ) and \hat{z}(0)=g(Σ_{k=1, . . . , M}_{_{z}} z^{k}) where g is the selection function.

The operation of the resonator network system 100 may be described for a current iteration t. The network nodes 102x, 102y and 102z may receive simultaneously or substantially simultaneously the respective triplet (s, ŷ(t), \hat{z}(t)), (s, \hat{x}(t), \hat{z}(t)) and (s, \hat{x}(t), ŷ(t)). The three network nodes may compute the unbound versions \tilde{x}(t), \tilde{y}(t) and \tilde{z}(t) of the hypervectors that represent the set of concepts respectively as follows: \tilde{x}(t)=s\textcircled{/}ŷ(t)\textcircled{/}\hat{z}(t), \tilde{y}(t)=s\textcircled{/}\hat{x}(t)\textcircled{/}\hat{z}(t) and \tilde{z}(t)=s\textcircled{/}\hat{x}(t)\textcircled{/}ŷ(t), where \textcircled{/} refers to blockwise unbinding. This may be referred to as an inference step. That is, the nodes may perform the inference step on respective input triplets. The blockwise unbinding of hypervectors may, for example, be performed using the circular correlation between the hypervectors.

The similarity of the unbound version \tilde{x}(t) with each of the Mₓ code hypervectors x¹ . . . x^{M}^{ₓ} may be computed using the codebook X stored in memory 104x as follows: aₓ(t)=X^{T}\tilde{x}(t)∈ [symbol] for multiplying the hypervector \tilde{x}(t) by the matrix X^{T}. The similarity of the unbound version \tilde{y}(t) with each of the M_{y} code hypervectors y¹ . . . y^{M}^{_{y}} may be computed using the codebook Y stored in memory 104y as follows: a_{y}(t)=Y^{T}\tilde{y}(t)∈ [symbol] for multiplying the hypervector \tilde{y}(t) by the matrix Y^{T}. The similarity of the unbound version \tilde{z}(t) with each of the M_{z} code hypervectors z¹ . . . z^{M}^{_{z}} may be computed using the codebook Z stored in memory 104z as follows: a_{z}(t)=Z^{T}\tilde{z}(t)∈ [symbol] for multiplying the hypervector \tilde{z}(t) by the matrix Z^{T}. The resulting vectors aₓ(t), a_{y}(t) and a_{z}(t) may be named similarity vectors or attention vectors. The largest element of each of the similarity vectors aₓ (t), a_{y}(t) and a_{z}(t) indicates the code hypervector which matches best the unbound version \tilde{x}(t), \tilde{y}(t) and \tilde{z}(t) respectively.

After computing the similarity vectors, the similarity vectors aₓ(t), a_{y}(t) and a_{z}(t) may optionally be sparsified using the activation function kact implemented by the activation units 106x, 106y and 106z respectively. The sparsification of the similarity vector may be performed by activating a portion of the elements of the similarity vector. For that, the activation function kact may be used to activate said portion of elements as follows: a′ₓ(t)=kact(a_{y}(t)), a′_{y}(t)=kact(a_{y}(t)) and a′_{z}(t)=kact(a_{z}(t)). The modified/sparsified similarity vectors a′ₓ(t), a′_{y}(t) and a′_{z}(t) may be the output of the similarity step. Thus, for each concept of the set of concepts, the similarity step may receive as input the respective one of the unbound versions \tilde{x}(t), \tilde{y}(t) and \tilde{z}(t) and provide as output the respective one of the modified similarity vectors a′ₓ(t), a′_{y}(t) and a′_{z}(t).

After obtaining the modified similarity vectors a′ₓ(t), a′_{y}(t) and a′_{z}(t), a superposition step may be applied on the modified similarity vectors a′ₓ(t), a′_{y}(t) and a′_{z}(t). In case the sparsification is not performed, the superposition step may be performed on the similarity vectors aₓ(t), a_{y}(t) and a_{z}(t).

In one first example implementation of the superposition step, a weighted superposition of the modified similarity vectors a′ₓ(t), a′_{y}(t) and a′_{z}(t) may be performed using the codebooks X^{T}, Y^{T} and Z^{T} stored in memories 108x, 108y, and 108z respectively. This may be performed by the following matrix vector multiplications: Xa′ₓ(t), Ya′_{y}(t) and Za′_{z}(t). The resulting hypervectors Xa′ₓ(t)), Ya′_{y}(t)) and Za′_{z}(t) may be fed to the selection units 110x, 110y and 110z respectively. This may enable to obtain the estimate of the hypervectors \hat{x}(t+1), ŷ(t+1) and \hat{z}(t+1) respectively for the next iteration t+1 as follows: \hat{x}(t+1)=g(Xa′ₓ(t)), ŷ(t+1)=g(Ya′_{y}(t)) and \hat{z}(t+1)=g(Za′_{z}(t)). This may enable the superposition step of the iterative process. For each concept of the concepts the superposition step may receive as input the respective one of the modified similarity vectors a′ₓ(t), a′_{y}(t) and a′_{z}(t) and provides as an output the respective one of the hypervectors \hat{x}(t+1), ŷ(t+1) and \hat{z}(t+1). Hence, the estimate of the hypervectors representing the set of concepts respectively may be defined according to the present system as follows \hat{x}(t+1)=g(Xkact(X^{T} (s\textcircled{/}ŷ(t)\textcircled{/}\hat{z}(t)))), ŷ(t+1)=g(Ykact(Y^{T} (s\textcircled{/}\hat{x}(t)\textcircled{/}\hat{z}(t)))) and \hat{z}(t+1)=g(Zkact(Z^{T} (s\textcircled{/}\hat{x}(t)\textcircled{/}ŷ(t)))) where g is the selection function.

The iterative process may stop if a stopping criterion is fulfilled. The stopping criterion may, for example, require that \hat{x}(t+1)=\hat{x}(t), ŷ(t+1)=\hat{z}(t) and \hat{z}(t+1)=\hat{z}(t) or that a maximum number of iterations is reached.

FIG. 2 is a flowchart of a method for performing factorization using a factorization system comprising a resonator network e.g., as described with reference to FIG. 1. For each step of the iterative process alternative implementations of the step may be provided in step 201. An input hypervector representing a data structure may be received in step 203. For each step of the iterative process, a specific implementation of the step may be selected in step 205 from the provided implementations. The iterative process may be executed in step 207 using the selected implementations. This may result in factorizing the input hypervector.

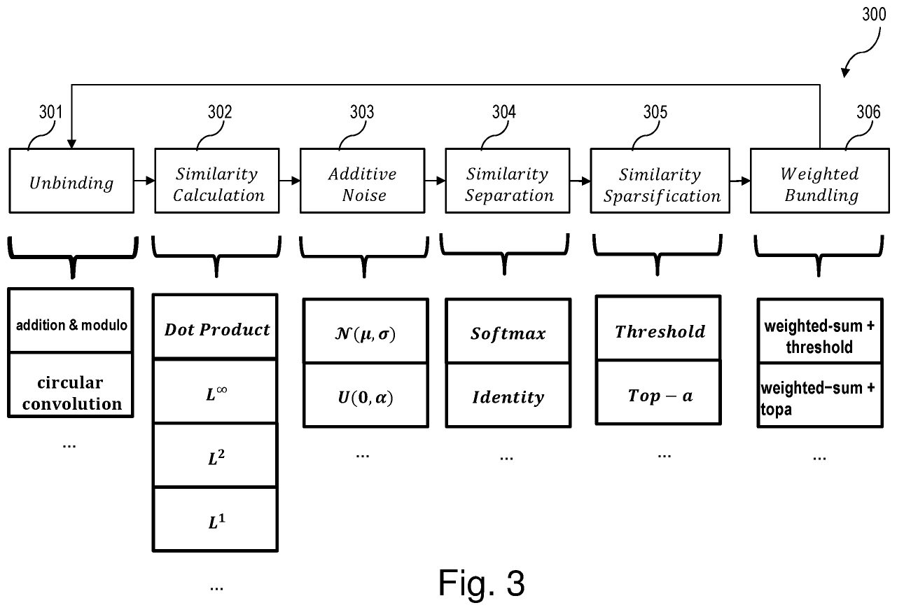

FIG. 3 is a diagram of a modular structure of a factorization system in accordance with an example of the present subject matter.

The factorization system 300 may, for example, be a resonator network as described with reference to FIG. 1. The factorization system 300 is configured for performing an iterative process to factorize an input hypervector into individual hypervectors representing a set of concepts respectively. The iterative process comprises for each concept of the set of concepts the unbinding step 301, a similarity calculation step 302, additive noise step 303, similarity separation step 304, similarity sparsification step 305 and a weighted bundling step 306. As indicated in FIG. 3, these steps are executed in each iteration of the iterative process.

Each step of the iterative process may be implemented using alternative implementations or methods. This is indicated in FIG. 3, where each step is associated with different modules each indicating the implementation option of the step. FIG. 3 shows the individual steps along with a selection of modules one can use in each step. This may enable to identify a configurable, modular structure to the iterations of the factorization system. Each step in the iteration is configurable.

Hence, appropriately selected and configured modules can have a significant positive impact on both factorization accuracy and noise resilience.

To configure the factorization system 300, an optimal number of the factors and codebooks may be chosen. To find the optimal number of the factors and codebooks, a grid-search-related algorithm can be used. For example, a search may be performed so that the number of the factors F may be significantly smaller than the codebook size M, i.e., F<<M.

Multiple characteristics to identify the modular sparse factorization aspect of the factorization system 300 may be as follows. Any system factorizing a given D-dimensional product vector in less time than a brute-force approach. The input may be in the sparse domain. The input does not have to lie within the domain of binary sparse block code, or sparse block code. Any product vector with a relatively small number of nonzero elements with real-valued values may be applicable. The system's output defines a set of F factors, necessarily revealing the number of the factors the system operates with. The number of the output factors F should be in the range of the optimal number of the factors.

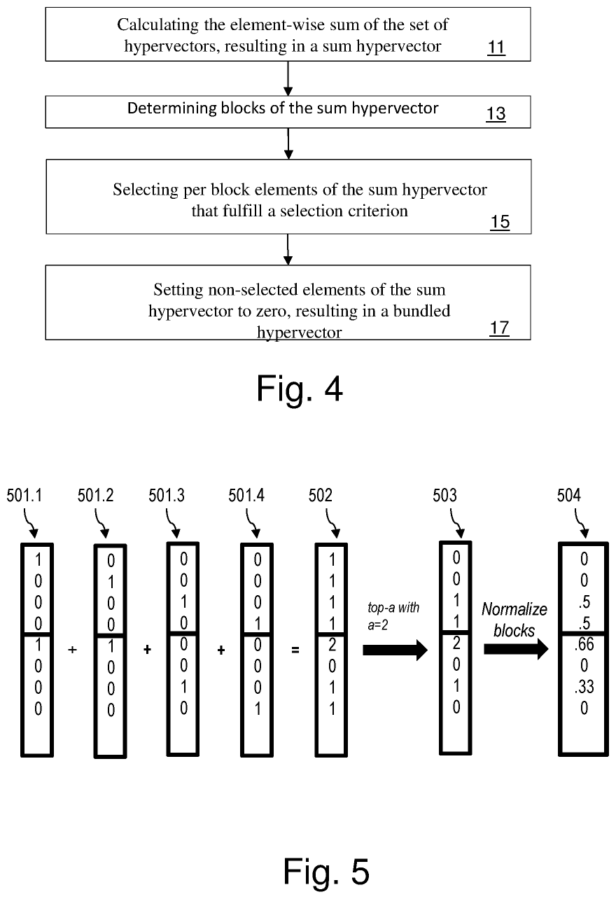

FIG. 4 is a flowchart of a method for bundling a set of hypervectors in accordance with an example of the present subject matter. The method of FIG. 4 may provide an example implementation of step 306 of FIG. 3.

The element-wise sum of the set of hypervectors may be computed in step 11. This may result in a hypervector named sum hypervector. The blocks of the sum hypervector may be determined in step 13. For example, the sum hypervector may be segmented into a defined number of blocks. Alternatively, the set of hypervectors may be segmented into the defined number of blocks, and the sum hypervector may automatically obtain the block structure. Elements of each block of the sum hypervector that fulfill a selection criterion may be selected in step 15. The non-selected elements of the sum hypervector may be set in step 17 to zero in the sum hypervector, resulting in a bundled hypervector. The selected elements are preserved.

FIG. 5 is a diagram illustrating the bundling operation in accordance with an example of the present subject matter. The method illustrated in FIG. 5 may provide an example implementation of step 306 of FIG. 3.

Four hypervectors 501.1 through 501.4 are to be bundled. Each hypervector of the four hypervectors 501.1 through 501.4 may comprise two blocks. The sum of the four hypervectors 501.1 through 501.4 may be performed element-wise to obtain the sum hypervector 502. A selection of the a-many largest elements per block of the sum hypervector 502 may be performed. In the example of FIG. 5, a=2. The selected elements are unmodified, while all others are set to 0. This may result in the hypervector 503. The blocks of the hypervector 503 are then normalized in order to obtain the bundled hypervector 504. This bundling procedure may have a significantly larger bundling capacity compared to the previous state-of-the-art. In this example, the bundling result 504 has non-zero similarity with all four input hypervectors 501.1 through 501.4.

FIG. 6 is a diagram illustrating the bundling operation in accordance with an example of the present subject matter. The method illustrated in FIG. 6 may provide an example implementation of step 306 of FIG. 3.

Four hypervectors 601.1 through 601.4 are to be bundled. Each hypervector of the four hypervectors 601.1 through 601.4 may comprise two blocks. The sum of the four hypervectors 601.1 through 601.4 may be performed element-wise to obtain the sum hypervector 602. All elements of the sum hypervector 602 may be compared with a fixed threshold value. The elements that exceed the threshold are preserved, while all others are set to 0. In each block, if no element exceeds the threshold, the entire block is preserved. This may result in the hypervector 603. The blocks of the hypervector 603 are then normalized in order to obtain the bundled hypervector 604. This threshold-based bundling operation may be more amenable to hardware implementations as it may reduce to element-wise comparisons. The variance in the number of activated elements may be significantly larger than that of the top-a based implementation shown in FIG. 5.

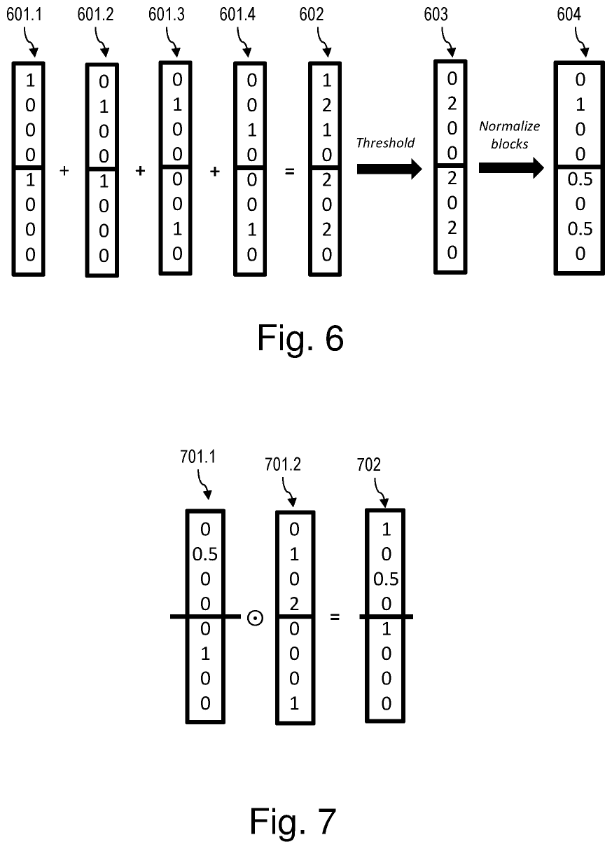

FIG. 7 is a diagram illustrating the binding operation in accordance with an example of the present subject matter. Two hypervectors 701.1 and 701.2 are to be bound. Each hypervector of the two hypervectors 701.1 and 701.2 may comprise two blocks. The binding operation of the hypervectors 701.1 and 701.2 may be performed by computing the circular convolution of the hypervectors 701.1 and 701.2. This may result in the bound hypervector 702. This binding operation may address the following limitation of existing technique. The existing binding operation for binary sparse block-codes may exploit a single active element per sparse block. This may significantly limit the maximum amount of information per hypervector. The unbinding operation may be performed using the circular correlation. The binding/unbinding may allow inputs with any sparsity level. The binding/unbinding may allow inputs with any floating-point value.

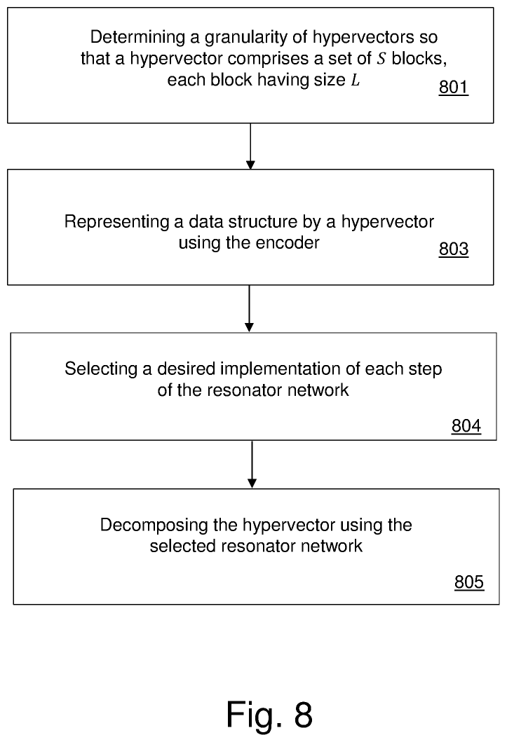

FIG. 8 is a flowchart of a method for factorizing a hypervector in accordance with an example of the present subject matter. The hypervectors may comprise zero values and non-zero (e.g., one) values.

A granularity of hypervectors may be determined in step 801 so that a hypervector comprises a set of S blocks, each block having size L≥1, wherein D=S×L. For example, the block size may be higher than one, L>1. In other words, step 801 comprises determining for each hypervector a set of S blocks, each block having size L, where D=S×L. For example, the hypervector may be segmented or divided into a number of blocks that is equal to the number of non-zero values (e.g., non-zero value=1) in the hypervector so that each block may comprise one non-zero value. Each processed hypervector may have the same number S of blocks, but the positions/indices of the non-zero values within blocks may differ between the hypervectors.

A data structure may be represented in step 803 by a hypervector s using an encoder such as a VSA based encoder. The data structure may, for example, be a query image representing a visual scene. The encoder may be a feed-forward neural network that is trained to produce the hypervector s as a compound hypervector describing the input visual image. The image may comprise coloured MNIST digits. The components of the image may be the colour, shape, vertical and horizontal locations of the letters in the image. The encoder may, for example, be configured to compute a hypervector for each letter in the image by multiplying the related quasi-orthogonal hypervectors drawn from four fixed codebooks of four concepts: colour codebook (with 7 possible colours), shape codebook (with 26 possible shapes), vertical codebook (with 50 locations), and horizontal codebook (with 50 locations). The product vectors for every letter are added (component-wise) to produce the hypervector s describing the whole image.

For each step of the iterative process of the resonator network a desired implementation may be selected in step 804. For example, as shown in FIG. 3, for each step 301 to 306, the desired implementation may be selected from the provided possible implementations. E.g., the circular convolution implementation may be chosen for step unbinding 301, the L² norm implementation may be chosen for the similarity step 302, the gaussian noise implementation may be chosen for the adding noise step 303, the softmax implementation may be chosen for the similarity separation step 304, the threshold based sparsification implementation may be chosen for the sparsification step 305 and the threshold weighted-sum implementation may be chosen fort the weighted bundling step 306.

The hypervector s may be decomposed in step 805 using the resonator network in accordance with the chosen or selected implementations and the determined blocks. The resonator network is configured to receive the input hypervector s and to perform an iterative process to factorize the input hypervector into individual hypervectors representing the set of concepts respectively. The iterative process comprises for each concept of the set of concepts: an inference step for computing an unbound version of a hypervector representing the concept by a blockwise unbinding operation between the input hypervector and estimate hypervectors of the other concepts, a similarity step to compute a similarity vector indicating a similarity of the unbound version with each candidate code hypervector of the concept, and a superposition step to generate an estimate of a hypervector representing the concept by a linear combination of the candidate code hypervectors, with weights given by the similarity vector. The superposition step may, for example, be performed as described with reference to FIG. 1. The iterative process may stop if a convergence criterion is fulfilled. The convergence criterion may, for example, may require a predefined number of iterations to be reached or the difference between the current estimate of a hypervector representing each concept and the last estimate of a hypervector representing said each concept is smaller than a threshold.

Computing environment 1800 contains an example of an environment for the execution of at least some of the computer code involved in performing the inventive methods, such as a code for hypervector factorization engine 1900. In addition to block 1900, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1900, as identified above), peripheral device set 1814 (including user interface (UI) device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

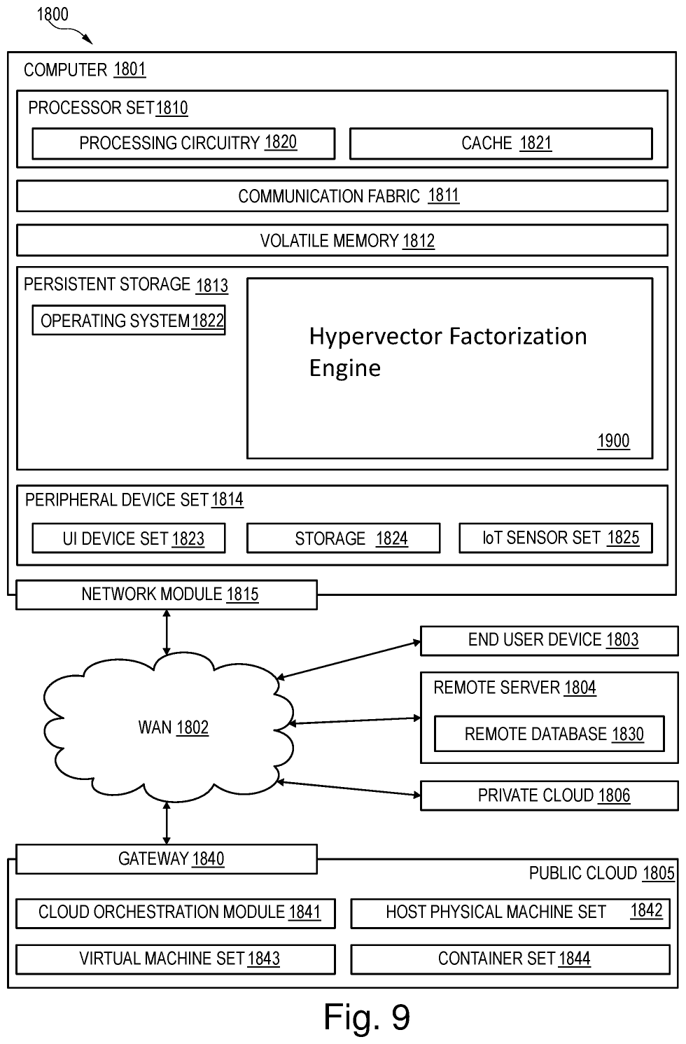

COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 9. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods may be stored in block 1900 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, volatile memory 1812 is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface-type operating systems that employ a kernel. The code included in block 1900 typically includes at least some of the computer code involved in performing the inventive methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN 1802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A computer-implemented method to factorize an input hypervector representing a plurality of concepts into individual hypervectors each representing a concept from a the plurality of concepts, through iterative processing of a resonator network, the computer-implemented method comprising:
receiving an input hypervector representing a data structure comprised of a plurality of concepts;
unbinding, by the processor, the input hypervector, into a plurality of unbound hypervectors, wherein the each of the plurality of unbound hypervectors corresponds to a single concept from the plurality of concepts of the data structure;
generating, by the processor, one or more similarity vectors for each of the unbound hypervectors, wherein each of the one or more similarity vectors is based on the similarity of the unbound hypervector and one or more candidate code hypervectors representing each of the plurality of concepts; and
generating, by the processor, a plurality of a principal hypervectors, wherein each principal hypervectors is an estimate which represents one concept of the plurality of concepts, based at least in part on the one or more similarity vectors corresponding to the one concept.

2. The computer-implemented method of claim 1, wherein generating a similarity vector is based on one of the following: a dot product, L1 norm, L2 norm, or L\hat{ }∞ norm.

3. The computer-implemented method of claim 1, wherein unbinding the input hypervector is based on a circular convolution or an addition and modulo operation.

4. The computer-implemented method of claim 1, further comprising:
adding, by the processor, noise to the similarity vector of the hypervector, wherein the noise is gaussian noise or uniform noise.

5. The computer-implemented method of claim 1, further comprising:
separating, by the processor, the similarity vectors, based on a softmax operation or an identity operation.

6. The computer implemented method of claim 1, further comprising;
sparsifying, by the processor, one or more elements of the similarity vectors, wherein sparsifying is based on one or the following: a pre-determined threshold, a dynamic threshold, a Top-A operation, or an absolute value larger than a mean of all.

7. The computer-implemented method of claim 6, wherein generating the plurality of principal hypervectors comprises:
combining, by the processor, through a linear combination each of the candidate code hypervectors with weights to generate a plurality of bundled weights, based on the sparsified similarity vector corresponding to the candidate code hypervector; and
applying, by the processor, the plurality of bundled weights to a selection function.

8. The computer-implemented method of claim 1, wherein the computer implemented method to factorize an input hypervector representing a plurality of concepts into individual hypervectors each representing a concept from a the plurality of concepts, through iterative processing of a resonator network performs a plurality of iterations until a convergence criterion is fulfilled.

9. The computer-implemented method of claim 8, wherein the convergence criteria is when a value of at least one element of each of the plurality of similarity scores exceeds a threshold.

10. The computer-implemented method of claim 8, wherein the convergence criteria is when a predefined number of iterations.

11. A computer system to factorize an input hypervector representing a plurality of concepts into individual hypervectors each representing a concept from a the plurality of concepts, through iterative processing of a resonator network, the computer system comprising:
one or more computer processors;
one or more computer readable storage devices;
program instructions stored on the one or more computer readable storage devices for execution by at least one of the one or more computer processors, the program instructions comprising:
receive an input hypervector representing a data structure comprised of a plurality of concepts;
unbind by the input hypervector, into a plurality of unbound hypervectors, wherein the each of the plurality of unbound hypervectors corresponds to a single concept from the plurality of concepts of the data structure;
generate one or more similarity vectors for each of the unbound hypervectors, wherein each of the one or more similarity vectors is based on the similarity of the unbound hypervector and one or more candidate code hypervectors representing each of the plurality of concepts;
generate a plurality of a principal hypervectors, wherein each principal hypervectors is an estimate which represents one concept of the plurality of concepts, based at least in part on the one or more similarity vectors corresponding to the one concept.

12. The computer system of claim 1, wherein generating a similarity vector is based on one of the following: a dot product, L1 norm, L2 norm, or L\hat{ }∞ norm.

13. The computer system of claim 1, wherein unbinding the input hypervector is based on a circular convolution or an addition and modulo operation.

14. The computer system of claim 1, further comprising:
add noise to the similarity vector of the hypervector, wherein the noise is gaussian noise or uniform noise.

15. The computer system of claim 1, further comprising:
separate the similarity vectors, based on a softmax operation or an identity operation.

16. The computer system of claim 1, further comprising;
sparsify one or more elements of the similarity vectors, wherein sparsifying is based on one or the following: a pre-determined threshold, a dynamic threshold, a Top-A operation, or an absolute value larger than a mean of all.

17. The computer system of claim 16, wherein generating the plurality of principal hypervectors comprises:
combine through a linear combination each of the candidate code hypervectors with weights to generate a plurality of bundled weights, based on the sparsified similarity vector corresponding to the candidate code hypervector; and
applying, by the processor, the plurality of bundled weights to a selection function.

18. The computer system of claim 1, wherein the factorizing an input hypervector representing a plurality of concepts into individual hypervectors each representing a concept from a the plurality of concepts, through iterative processing of a resonator network performs a plurality of iterations until a convergence criterion is fulfilled.

19. The computer system of claim 18, wherein the convergence criteria is when a value of at least one element of each of the plurality of similarity scores exceeds a threshold.

20. A computer program product to factorize an input hypervector representing a plurality of concepts into individual hypervectors each representing a concept from a the plurality of concepts, through iterative processing of a resonator network, the computer program product comprising:
one or more computer readable storage devices;
program instructions stored on the one or more computer readable storage devices, wherein the program instructions are executable by a computer processor to perform one or more operations, the operations comprising:
receive an input hypervector representing a data structure comprised of a plurality of concepts;
unbind by the input hypervector, into a plurality of unbound hypervectors, wherein the each of the plurality of unbound hypervectors corresponds to a single concept from the plurality of concepts of the data structure;
generate one or more similarity vectors for each of the unbound hypervectors, wherein each of the one or more similarity vectors is based on the similarity of the unbound hypervector and one or more candidate code hypervectors representing each of the plurality of concepts; and
generate a plurality of a principal hypervectors, wherein each principal hypervectors is an estimate which represents one concept of the plurality of concepts, based at least in part on the one or more similarity vectors corresponding to the one concept.
